(19) United States
(12) Patent Application Publication
(10) Pub. No.: US 2016/0058054 A1
(43) Pub. Date: Mar. 3, 2016

(54) AQUEOUS EXTRACT OF TOMATO-PROCESSING WASTE HAVING PLATELET ANTI-AG AND ANTITHROMBOTIC ACTIVITIES AND METHOD FOR THE PRODUCTION THEREOF

(71) Applicants: UNIVERSIDAD DE TALCA, Talca (CL); CENTRO DE ESTUDIOS EN ALIMENTOS PROCESADOS (CEAP), Talca (CL)

(72) Inventors: Iván Francisco Palomo Gonzalez, Talca (CL); Eduardo Javier Fuentes Quinteros, Curicó (CL)

(73) Assignees: UNIVERSIDAD DE TALCA, Talca (CL); CENTRO DE ESTUDIOS EN ALIMENTOS PROCESADOS (CEAP), Talca (CL)

(21) Appl. No.: 14/783,511

(22) PCT Filed: Apr. 11, 2014
(86) PCT No.: PCT/CL2014/000017

§ 371 Date: Oct. 9, 2015

(30) Foreign Application Priority Data
Apr. 11, 2013 (CL) 979-2013

(51) Int. Cl. A23L 1/30

(52) U.S. Cl. CPC A23L 1/3002; A23V 2002/00

(57) ABSTRACT

A method of producing an aqueous extract from tomato agroindustrial waste (tomasa) includes i) milling or grinding solids resulting from the tomato agroindustrial waste (tomasa); ii) solubilizing the solids of i) with a solvent; iii) extracting selected compounds from ii) the solution by ultrasound; and iv) filtering the suspension to separate solids from tomasa aqueous extract; and obtaining tomasa aqueous extract.

### TECHNICAL FIELD

This disclosure relates to an aqueous extract of tomato-processing waste (tomasa) with platelet anti-ag and antithrombotic activities, which is produced in large amounts and has limited commercial value, and of food additives containing the aqueous extract used for mass consumption food production, for instance, flour, yoghurt and juice matrixes to produce multiple byproducts such as bread, cookies, snacks, pasta, juices and yoghurt, among others.

### BACKGROUND

Nowadays, nutrition is experiencing a change in certain areas of interest. Consequently, although nutritional deficiencies are a top priority in the health field, today's interest is also focused on the relationship between food and non-communicable chronic disease prevention.

Consumers are increasingly aware of their diet and look for products contributing to their health and wellness, especially foods having a beneficial action on some physiological processes and/or reduce risk of having a disease.

For some decades now, Cardiovascular Diseases (CVD) including acute myocardial infarction, stroke and Peripheral Arterial Disease have been the leading cause of death worldwide, representing 30%, according to 2009 World Health Organization figures. Chile is not apart from this reality since these diseases cause 27% of deaths in the country, according to 2012 National Statistics Institute of Chile (Instituto Nacional de Estadistica de Chile, INE).

Within that context, diet has been identified (together with exercise and stop smoking) as the main way of reducing CVD deaths, the diet being rich in fruits and vegetables. In this sense, tomatoes have been one of the vegetables of greatest power to contribute to reducing this type of disease.

In the last ten years, CVDs have been studied in the Chilean population (Programa de Investigación en Factores de Riesgo Cardiovascular). In that context, research has been initiated about the biological activities of fruits and vegetables, for instance, determining antithrombotic activity of fruit and vegetable extracts widely used in the central area of Chile (Torres-Urrutia et al. Blood Coagul Fibrinolysis. 2011 April: 22(3):197-205), especially, for CVD primary prevention.

Thus, healthy effects of tomatoes (Solanum lycopersicum) have been studied apart from its known antioxidant activity (Palomo et al. Rev. Chil. Nutr. June 2009: 36 (2):152-158), both as fresh fruit and processed product (Bustamante et al. Rev. Med. Maule 2012: 28 (1):8-11).

Tomatoes are known for their compounds that inhibit platelet aggregation induced by thrombin, and already known adenosine (Dutta-Roy et al. Platelets. 2001 June; 12(4):218-227). In vitro and in vivo research has detected that tomato extract has natural antithrombotic effects (Yamamoto J. et al. Br J Nutr. 2003; 90-1031-1038). Particularly, a potential mechanism is revealed as to how tomato aqueous extract inhibits platelet aggregation (Lazarus S, Garg M. Int J Food Sci Nutr. 2004: 55:249-256). Analysis of tomato extract fractions allowed isolating the compounds responsible for inhibiting platelet aggregation (O'Kennedy N, et al. Am J Clin Nutr. 2006; 84:570-579). An additional study shows the effect of tomato extract administration as a dietary supplement for CVD prevention (O'Kennedy N, et al. Am J Clin Nutr. 2006; 84:561-569).

Palomo I. et al. (Rev Chil Nutr. 2010; 37:524-533) shows that consuming tomatoes on a regular basis provides antioxidant, hypolipidemic and antiplatelet effects. Additionally, they demonstrated that tomato processing does not deteriorate its biological activity to a greater extent and improves lycopene bioavailability. Palomo et al. also highlights that effects on lipid-lowering activity and tomato antiplatelet effects have not been studied well. Several studies have been carried out to evaluate the antithrombotic activity of widely consumed fruits and vegetables in Chile, among which tomato extract has been outlined as one of those having greatest antiplatelet inhibition capacity induced by ADP and arachidonic acid (Torres-Urrutia C, et al. Blood Coagul Fibrinolysis. 2011; 22:197-205).

Subsequent studies have evaluated and characterized tomato activity as antiplatelet agent using tomato aqueous and metabolic extract. Additionally, antiaggregant principles of different fractions were isolated showing that they did not have lycopene, but they did contain nucleosides (Fuentes E J, et al. Blood Coagul Fibrinolysis 2012; 23:109-117; Fuentes E, Castro I, Astudillo L, Gutiérrez M, Palomo I. Evidence-Based Complementary and Alternative Medicine, 2012: 1-10).

In WO 99/55350 A1, the use of a fruit extract or its active fraction has been disclosed as prophylaxis or treatment method of a disease state initiated by platelet aggregation. The fruit extract or active fraction has been obtained from peeled, seedless fruits belonging to families Solanaceae, Rutaceae, Cucurbitaceae, Rosaceae, Musaceae, Anacardiaceae, Bromeliaceae, Vitaceae, Arecaceae, Ericaceae and Lauraceae. Tomato extract active compounds have been analyzed by mass spectrometry and Magnetic Resonance Imaging, concluding that they correspond to a mixture of nucleosides.

On the other hand, US 2009/0123584 A1 refers to an active fraction of tomato to produce a drug that allows preventing and inhibiting venous thrombosis and fibrin clot formation, where the extract can be administered in patients with higher risk of suffering venous thrombosis by virtue of pertaining to one or more (in any combination) of the following risk situations: obesity, fractures, use of oral contraceptives, hormone replacement therapy, pregnancy, cancer, chemotherapy, antiphospholipid syndrome and hereditary thrombophilia.

EP 1423020 B1 discloses a composition of tomato lycopene and other phytonutrients including phytoene, phytofluene, tocopherols, phytosterols and beta-carotene as opposed to other lycopene products currently available in the market. Clinical studies show that a higher intake of tomato lycopene is associated with lower risk of CVD; besides, it can also offer additional benefits to handling blood pressure.

In Chile, the VII Maule Region concentrates about 66% of industrial tomato production. Processed tomato production by season is close to 600,000 tons in the region. This production generates a waste known as tomasa, corresponding to tomato peel and seeds after its processing to obtain paste. About 18,000 tons of tomasa are generated every season in this region and, nowadays, it is sold at very low price or given for animal consumption.

This waste is generally used as nutritional supplement for animals. Additionally, waste not consumed by animals contaminates the agricultural land.

In view of the contamination problem caused by the tomato industry, it could be helpful to use tomasa for production of a functional product with antithrombotic properties that may be useful as additive in healthy foods and, thus, prevent CVDs.

### BRIEF DESCRIPTION OF THE DRAWINGS

FIG. 1 shows the inhibiting effect of platelet aggregation of in vitro tomasa aqueous extract, using 8 μM ADP as agonist. Differences are observed in the slope, the area below the curve and in maximum aggregation (n=3 experiments).

FIG. 2 shows tomasa waste aqueous extract effect on arterial thrombosis formation in vivo, where Occ is occlusion percentage.

FIG. 3 shows a flow diagram of the process of obtaining tomasa waste aqueous extract, as well as subsequent lyophilizing to obtain powdered tomasa waste product.

### DETAILED DESCRIPTION

We provide a tomato aqueous extract—a byproduct of tomato agroindustrial processing tomato—having antithrombotic and antiplatelet properties, and a huge effect on CVDs prevention. Moreover, the aqueous extract analysis, obtained from tomasa, determines that this extract has much more effective antithrombotic power than tomatoes themselves, which represents an unexpected result.

The waste of tomato industrial processing (tomasa), causing agricultural land contamination is treated to obtain an aqueous extract or powder extract with antithrombotic and antiplatelet properties and that can be used as a food additive.

The resulting tomasa extract contributes in reducing cardiovascular risk factors and in adding value to tomasa.

There is a huge amount of agroindustrial waste derived from tomato processing, referred as tomasa waste. At the same time, anticlotting and antithrombotic compounds have been identified in tomatoes.

According to the above, we provide a tomasa waste extract with antiplatelet and antithrombotic properties that can be used as a food additive such as bioactive additive (regardless of present compound structure) based on agroindustrial tomasa waste with antiplatelet and antithrombotic properties.

The process for obtaining an extract based on tomato or tomasa agroindustrial waste is comprised of the following stages:

i) Milling or grinding solids;

ii) Solubilizing solids of step i) using a solvent;

iii) Extracting compounds of interest from step ii) solution by ultrasound; and

iv) Filtering the suspension to separate solids from tomasa waste aqueous extract.

The raw material used was obtained from waste of tomatoes (tomasa waste) processing industry of Sugal Chile (Talca and Quinta de Tilcoco plants). Tomasa waste corresponding mainly to the skin and seeds of tomatoes can be subject to a drying process, for example, in an oven at 60° C. for two days to eliminate water content present in the mixture. The product, corresponding to irregular size solids, is subject to a milling or grinding process to generate a thick powder of tomasa waste, reducing in this way particle size and increasing the exposure area to solvent in the following stage, and making the extraction process easier. Next, ground solids are dissolved in solvent (such as distilled water or drinking water) to form a suspension to dissolve the compounds present in those ground solids (dried and milled tomasa waste) which are soluble in the solvent, and extract them in the form of an aqueous solution. The previous mixture corresponding to suspension solids is subject to an extraction stage where compounds of interest are extracted by ultrasound, to break the walls of vegetable cells and release, in this way, soluble compounds present inside those cells in the solvent of choice.

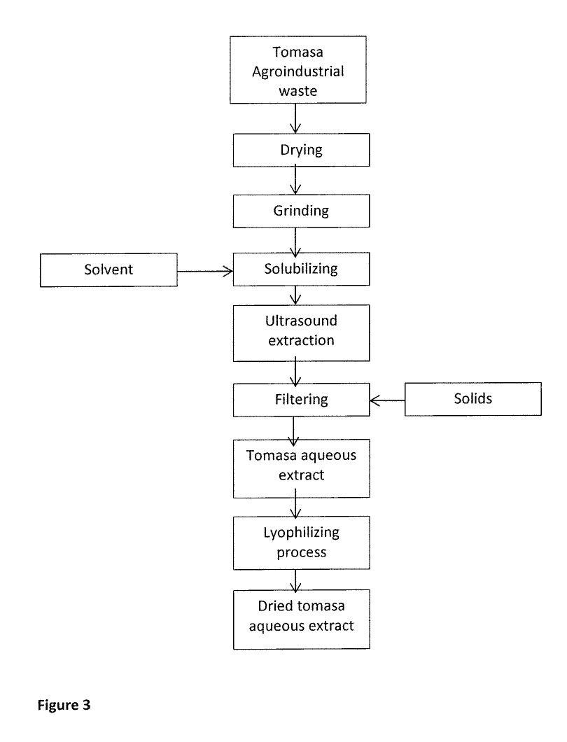

Afterwards, the suspension is subject to a filtering process to separate the solids from the liquid by, for example, membranes or dressing. The liquid obtained from this process is the aqueous extract of tomasa waste, which, optionally, can be subject to a drying process to obtain the dried aqueous extract of tomasa waste. The drying process can be carried out by a lyophilizing process to be stored for later use in functional foods (see process diagram flow in FIG. 3).

Preferably, tomasa waste is directly milled or ground considering that the drying process is not essential to obtain the aqueous extract. However, dried tomasa waste favors milling and, consequently, the extraction process and performance of the extract obtained. Next, solids resulting from tomasa waste milling are solubilized using a solvent and compounds of interest are extracted by ultrasound. Finally, the suspension is filtered and solids are separated from the tomasa waste aqueous extract.

Also preferably, the aqueous extract of tomasa waste obtained after the filtering stage is subject to lyophilizing process to produce a dried aqueous extract of tomasa. The process produces the least modifications in the product and loss of components.

We detected that the activity remained changeless as the activity observed in the aqueous extract produced before the lyophilizing stage.

### Example 1

Tomasa waste was dried in oven at 60° C. during two days, then ground and dissolved with a proportion of 1 g of tomasa every 1 ml of distilled water. The suspension was processed by ultrasound for 5 minutes and filtered twice by dressing. The aqueous extract obtained was lyophilized to generate a dried aqueous extract of tomasa waste and stored at −80° C. until use.

Based on the Codex Alimentarius, tomato byproducts can be contaminated with chemical products such as insecticides, weed-killers and the like since the skin of tomatoes is directly exposed to these chemical substances. In spite of that, multi-residue pesticide analysis F-H revealed the presence of three compounds: difenoconazole, pyrimethanil and lambda-cyalothrin, in concentrations within allowed levels, that is below Maximum Residue Limit (MRL) of tomasa (see Table 1).

TABLE 1

| | | Limit of | Maximum |
|---|---|---|---|
| | Result | Quantitation | Residue Limit |
| Analysis | mg/kg (ppm) | (LOQ) mg/kg (ppm) | (MRL) mg/kg |
| Difenoconazole | 0.051 | 0.010 | 0.5 |
| Pyrimethanil | 0.010 | 0.010 | 0.7 |
| Lambda-cyalothrin | 0.020 | 0.010 | 0.1 |

(*) Food Standards FAO/WHO CODEX Alimentarius
(**) (EU) Regulation No. 459/2010 of May 27, 2010 Commission
<LOQ = Lower than Quantitation Limit
MRL = Maximum Residue Limit of tomato

On the other hand, tomasa waste microbiological analysis complied with the standard: Total Count <30000 (UFC/g), Yeast <5000 (UFC/g), Total Coliforms <10 (UFC/g), S. aureus <10 (UFC/g), E. coli <10 (UFC/g) and absence of Salmonella (in 25 g).

Among bioactive principles present in tomato or byproducts thereof, we can mention: tocopherols, phytosterols, carotenoids (mainly lycopene) and adenosine (platelet function inhibitor) (Vági E, Simándi B, Vásárhelyiné K P, Daood H, Kéry Á, Doleschall F, Nagy B: The Journal of Supercritical Fluids 2007; 40:218-226). Additionally, tomasa contains tomato seeds, made up of other compounds such as unsaturated fats (linoleic acid, oleic acid and palmitic acid, among others) (Camara M, Del Valle M, Torija M, Castilho C: ISHS Acta Horticulturae 542: VII International Symposium on the Processing Tomato 542 2001:175-180; Giannelos P, Sxizas S, Lois S, Zannikos F, Anastopoulos G. Industrial Crops and Products 2005; 22:193-199). It has been proved that linoleic acid was capable of inhibiting arterial thrombosis formation, tissue factor expression and platelet aggregation (Holy, E. W., Forestier, M., Ritcher, E. K., Akhmedov, A., et al. Arteriosclerosis, Thrombosis, and Vascular Biology 2011, 31, 1772-1780).

Moreover, it has been reported that alpha-tocopherol inhibits platelet aggregation by a KPC dependent mechanism, which can explains the reduction in P-selectin expression (Freedman, J. E., Farhat, J. H., Loscalzo, J., Keaney, J. F. Circulation. 1996, 94, 2434-2440, Murohara, T., Ikeda, H., Otsuka, Y., Aoki, M., et al. Circulation. 2004, 110, 141-148).

Chemical and biological characterization of powdered tomasa showed the following results:

a) Proximate Analysis
Proximate analysis is carried out on not processed tomasa (fresh). Tomasa contains about 28 mg of lycopene in 100 g of tomasa fresh matter, and total phenols corresponding to nearly 21 mg of gallic acid in 100 g of tomasa fresh sample. The result of proximate analysis is as follows: Total Protein 16.8%; Ash 4.7%; Raw Fiber 42.9%; Moisture 13.6%; Fat with Acid Hydrolysis 12.7%; Calcium 0.120%; Copper 8.990 mg/kg; Total Phosphor 0.440%; Iron 54.390 mg/kg; Sodium 0.0220%; Zinc 22.54 mg/kg and Non-nitrogenized Extract 9.3%.

b) Tomasa Antiplatelet Activity
The following are in vitro, in vivo and ex vivo evidences of tomasa antiplatelet activity:

In vitro Studies: By the analysis of tomasa in vitro antiplatelet activity, we observed a powerful anti-aggregation effect, which is independent from agonist used (ADP, collagen, TRAP-6 and arachidonic acid).

Comparison of properties shown by the aqueous extract of tomato pulp and aqueous extract of tomasa waste. According to the analysis of tomasa aqueous extract, we determined that this extract has a more effective antithrombotic power than tomato itself, which represents an unexpected result. The aqueous extract of tomato pulp was only capable of inhibiting platelet aggregation in about 41+4 and 19+2% with ADP and collagen, respectively; while tomasa aqueous extract inhibited platelet aggregation using four agonists (ADP: 35+5%; collagen: 36+6%; TRAP-6: 22+4% and arachidonic acid: 20+3%). These results are shown in Tables 2, 3 and 4, where induced platelet aggregation inhibition is compared with negative control. Values in Tables 2, 3 and 4 are presented as an average+standard average error (n=3), where ADP agonist was used in 8 μM, collagen in 1.5 μ/mL, TRAP-6 in 30 μM and arachidonic acid in 1 Nm, while extracts were used at 1 mg/mL concentration. *P<0.05 versus negative control (0.9% saline solution).

TABLE 2
Platelet anti-aggregation activity of ripe and unripe tomato extracts.

| | Maximum Aggregation (%) | | | |
|---|---|---|---|---|
| | ADP | Collagen | TRAP-6 | AA |
| Ripe Tomato | | | | |
| Skin | 51 ± 0.08* | 71 ± 0.02* | 80 ± 0.03 | 74 ± 0.06 |
| Pulp | 53 ± 0.09* | 73 ± 0.04* | 83 ± 0.05 | 85 ± 0.06 |
| Seed mucilage | 37 ± 0.08* | 51 ± 0.14* | 78 ± 0.03 | 80 ± 0.09 |
| Unripe Tomato | | | | |
| Skin | 86 ± 0.02 | 84 ± 0.04 | 84 ± 0.02 | 76 ± 0.02 |
| Pulp | 48 ± 0.05* | 73 ± 0.02* | 78 ± 0.02 | 80 ± 0.09 |
| Seed mucilage | 42 ± 0.08* | 84 ± 0.09 | 72 ± 0.07 | 84 ± 0.06 |
| Negative Control | 85 ± 0.02 | 90 ± 0.04 | 91 ± 0.01 | 84 ± 0.14 |

AA, Arachidonic Acid
*p < 0.05

TABLE 3
Platelet anti-aggregation activity of tomasa extracts.

| | Maximum Aggregation (%) | | | |
|---|---|---|---|---|
| | ADP | Collagen | TRAP-6 | AA |
| Tomasa | 55 ± 0.12* | 58 ± 0.05* | 71 ± 0.04* | 68 ± 0.05* |
| aqueous | | | | |
| extract | | | | |
| Seed aqueous | 40 ± 0.09* | 10 ± 0.01* | 59 ± 0.06* | 59 ± 0.11* |
| extract | | | | |
| Petroleum | 26 ± 0.04* | 18 ± 0.03* | 23 ± 0.03* | 20 ± 0.05* |
| ether extract | | | | |
| Negative | 85 ± 0.02 | 90 ± 0.04 | 91 ± 0.01 | 84 ± 0.14 |
| control | | | | |

AA, Arachidonic Acid
*p < 0.05

TABLE 4
Platelet anti-aggregation activity of tomasa
aqueous extracts using four agonists.

| | Antiplatelet Inhibition (%) | | | |
|---|---|---|---|---|
| | | | | Arachidonic |
| | ADP | Collagen | TRAP-6 | Acid |
| Tomasa (1 mg/mL) | 35 ± 5* | 36 ± 6* | 22 ± 4* | 20 ± 3* |
| Tomato pulp (1 mg/mL) | 41 ± 4* | 19 ± 2* | NS | NS |

*p < 0.05

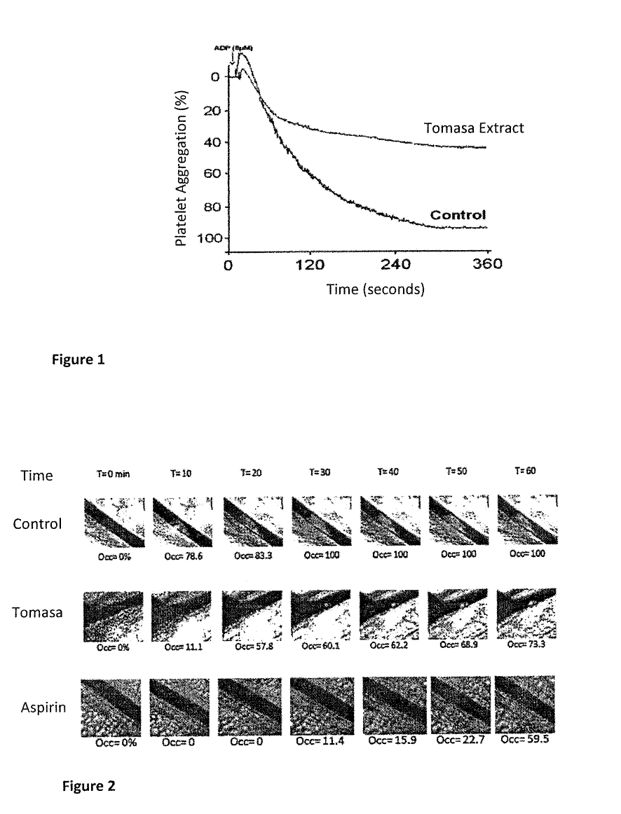

FIG. 1 shows a representation of inhibiting activity of tomasa extract, using ADP as agonist.

In vivo and ex vivo studies. In Wistar rats, we observed that oral administration of tomasa aqueous extract (1 g/kg/day during 15 days) extended the period of bleeding (study group 4.5+0.7 min. vs. control group 2.9+0.5 min., p<0.05) and reduced the area below the curve in the platelet aggregation study (study group 270+58 vs. control group 370+61, p<0.05) (see Table 5).

TABLE 5
Platelet anti-aggregation activity in rats
administered with a dose of tomasa.

| | | Platelet Aggregation | | | |
|---|---|---|---|---|---|
| | | | | Maximum | |
| | Bleeding | | | Aggre- | Area |
| | Time | Lag | | gation | below the |
| Dose | (min.) | Time (s) | Slope | (%) | curve |
| 1 | 4.5 ± 0.7*† | 0.3 ± 0.01 | 75 ± 7 | 49 ± 3* | 270 ± 58 |
| g/kg/day | | | | | |
| 0.1 | 2.9 ± 0.3* | 0.4 ± 0.1 | 82 ± 2 | 51 ± 2 | 277 ± 27 |
| g/kg/day | | | | | |
| Control | 2.9 ± 0.5† | 0.3 ± 0.1 | 88 ± 9 | 58 ± 5* | 370 ± 61 |

*p < 0.05;
†p < 0.05

c) Antiplatelet Activity of a Composition of Tomasa Aqueous Extract and Maltodextrin.
A composition of tomasa and maltodextrin was prepared in producing a biscuit with fresh tomasa. Powdered tomasa was mixed with maltodextrin, and the resulting mixture was tested proving that anti-aggregation platelet activity remained the same, concluding that there were no significant differences as regards the use of an additive in platelet aggregation inhibition.

d) Tomasa Antithrombotic Activity
To study how arterial thrombosis can be prevented in the mesenteric artery, animals (20-25 g mice) under anesthesia were administered saline solution (negative control), acetylsalicylic acid (positive control) or tomasa in a dose of 200 mg of tomasa/kg of body weight by intraperitoneal injection. Tomasa effect was examined in arterial thrombosis formation as shown in FIG. 2. During the time (60 min.) under which arterial blood flow was controlled, tomasa significantly inhibited arterial occlusion. Tomasa administration (occlusion: 73.3+1.5%, n=3) showed significant reductions in the size of arterial occlusion as compared to negative control (occlusion 100%, n=3) (p<0.05).

1-10. (canceled)

11. A method of producing an aqueous extract from tomato agroindustrial waste (tomasa), comprising:
i) milling or grinding solids resulting from the tomato agroindustrial waste (tomasa);
ii) solubilizing the solids of i) with a solvent;
iii) extracting selected compounds from the solution from ii) by ultrasound; and
iv) filtering the suspension to separate solids from tomasa aqueous extract; and obtaining tomasa aqueous extract.

12. The method according to claim 11, further comprising lyophilizing the aqueous extract to obtain a dried aqueous extract of tomasa.

13. The method according to claim 11, further comprising drying the tomasa prior to grinding.

14. The method according to claim 13, wherein the tomasa is dried at 60° C. for two days.

15. The method according to claim 11, wherein 1 g of tomasa is dissolved in a proportion of 1 ml distilled water, followed by application of ultrasound for 5 min and filtering twice by dressing.

16. Tomasa aqueous extract obtained by the method of claim 11, comprising lycopene and gallic acid fresh matter.

17. Dried tomasa aqueous extract obtained by the method of claim 12, comprising lycopene and gallic acid fresh matter.

18. A food composition comprising the tomasa aqueous extract of claim 16 and maltodextrin.

19. A food composition comprising dried tomasa aqueous extract from claim 17 and maltodextrin.

20. A biscuit comprising the food composition of claim 18.

21. A food additive having antiplatelet effect activity comprising the tomasa aqueous extract according to claim 16.

22. Flour, yoghurt or juice matrixes comprising the tomasa aqueous extract according to claim 21.

23. A food additive having antiplatelet effect activity comprising the dried tomasa aqueous extract according to claim 17.

24. Flour, yoghurt or juice matrixes comprising the dried tomasa aqueous extract according to claim 23.

25. The method according to claim 12, further comprising drying the tomasa prior to grinding.

26. The method according to claim 12, wherein 1 g of tomasa is dissolved in a proportion of 1 ml distilled water, followed by application of ultrasound for 5 min and filtering twice by dressing.

27. The method according to claim 13, wherein 1 g of tomasa is dissolved in a proportion of 1 ml distilled water, followed by application of ultrasound for 5 min and filtering twice by dressing.

28. The method according to claim 14, wherein 1 g of tomasa is dissolved in a proportion of 1 ml distilled water, followed by application of ultrasound for 5 min and filtering twice by dressing.
